(19) United States
(12) Patent Application Publication
(10) Pub. No.: US 2024/0367402 A1
(43) Pub. Date: Nov. 7, 2024

(54) BALING PRESS AND METHOD FOR OPERATING THE BALING PRESS

(71) Applicant: SIB Strautmann Ingenieurbüro GmbH, Glandorf (DE)

(72) Inventors: Ralf Birkemeyer, Hilter (DE); Jan Vogt, Melle (DE)

(73) Assignee: SIB Strautmann Ingenieurbüro GmbH, Glandorf (DE)

(21) Appl. No.: 18/255,677

(22) PCT Filed: Dec. 15, 2021
(86) PCT No.: PCT/EP2021/085906

§ 371 Date: Jun. 2, 2023

(30) Foreign Application Priority Data
Dec. 16, 2020 (DE) 10 2020 133 711.6

(51) Int. Cl. B30B 9/30; B30B 15/06; B30B 15/24

(52) U.S. Cl. CPC B30B 9/3007; B30B 9/3057; B30B 15/068; B30B 15/24

(57) ABSTRACT

A baling press and a method for operating the baling press. The baling press, or baler, has a baler housing surrounding a bale chamber, and a pressing plate that is movable in the baler housing and which can be driven by hydraulic cylinders arranged in pairs on two opposite sides outside the bale chamber. The baler has a hydraulic control device, by means of which the hydraulic cylinders of each pair of cylinders can each be controlled either selectively individually or jointly, depending on the press pressure. Furthermore, a method for operating the baling press, or baler is taught.

### CROSS REFERENCE TO RELATED APPLICATIONS

This application is the US national phase of and claims the benefit of and priority on International Application No. PCT/EP2021/085906 having an international filing date of 15 Dec. 2021, which claims priority on and the benefit of German Patent Application No. 10 2020 133 711.6 having a filing date of 16 Dec. 2020.

### BACKGROUND OF THE INVENTION

### Technical Field

The present invention relates to a baler with a baler housing surrounding a bale chamber, a pressing plate that is movable in the baler housing and which can be driven by hydraulic cylinders. Furthermore, the invention relates to a method for operating the baler.

### Prior Art

Known from DE 100 29 439 A1 is a baler with a housing surrounding a bale chamber and a press ram employed therein, the drive of which is formed by four hydraulic cylinders arranged laterally next to the baler housing. The hydraulic cylinder drive is uncontrolled. The cylinders are used as pressure cylinders. In other words: When the press ram moves downward, the piston surface of the cylinder is pressurized with hydraulic oil, when it moves upward, the piston ring surface is pressurized. Although a high pressing pressure can be generated in a baler with pressure cylinders, this construction method results in the disadvantage that the pressure cylinders basically protrude above the baler due to the design of the system. This is disadvantageous for spaces with low headroom.

Known from US 2013/0270730 A1 is a compression molding apparatus for melting a resin material in which fibers are supplied to the molten resin and the resin and fibers are then pressed into a mold. The compression molding apparatus includes a lower mold and an upper mold, and at least three compression hydraulic cylinders attached to the upper and lower molds. Position sensors are provided to detect the distance between the upper and lower mold. And according to which information the compression hydraulic cylinders can be controlled individually. The compression molding equipment is neither intended nor suitable for baling material.

Known from U.S. Pat. No. 5,868,067 A is a baler for compacting fibers and other compactible materials, such as refuse. The baler includes a primary hydraulic cylinder and a faster-acting secondary hydraulic cylinder, both of which are attached to a pressing plate designed for compacting the material. In this case, the second compression means works faster than the first compression means and exerts a tamping motion on the pressed material precompressed by the first compression means. Both compression means have a common hydraulic system and solenoid valve. The supply of hydraulic oil to the two hydraulic cylinders and the activation of the tamping strokes is performed by means of a control system provided for this purpose. The disadvantage of this system is that although two pairs of cylinders with a total of four cylinders are provided, the two secondary cylinders only serve to increase the lifting speed in the unloaded state. Material compaction is performed exclusively with the primary cylinders.

DE 195 28 813 A1 discloses a device for compensating tilting moments on a ram of a press. The device comprises at least one pair of identical hydraulic cylinders, the pistons of which are each connected to the ram. The hydraulic cylinders are constant velocity cylinders (also called constant speed cylinders), which have a piston rod on both sides of the piston surface. The volume of the hydraulic oil flowing in and out is therefore always the same. The cylinder thus also retracts and extends at the same speed. The chamber of each hydraulic cylinder located above the piston is connected to the chamber of the other hydraulic cylinder of the pair located below the piston via a connecting line in each case. Although the device known from DE 195 28 813 A1 is capable of detecting and compensating for an oblique position of the ram, such ram presses lack a bale chamber and are unsuitable as balers.

It is known from U.S. Pat. No. 5,570,630 A that a baler has two double-acting hydraulic cylinders. The hydraulic cylinders are connected by a bridge structure and two press plates attached to it. To control the angularity of the plate as it moves downward, and thus during compaction, two electrical switches are provided that are activated by a pin whenever the bridge structure connecting the hydraulic cylinders moves from its normally horizontal position to an inclined position. The disadvantage of the control system is that the cylinders can only be controlled roughly and fine control is not possible.

Known from AU 001991082616 A1 is a press for wool having a frame and a pressing plate retractable into a pressing chamber. To hold the compressed wool in its compressed position after pressing, wool holding elements are provided in the form of pins engaging laterally in the press bale, which are pierced into the wool bale from the sides after compaction and before the pressing plate is moved upwards. The pins engaging laterally in the pressing chamber thus serve as hold-down devices for the material to be compacted and prevent it from expanding when the pressing plate returns.

U.S. Pat. No. 3,851,577 A discloses a baler for pressing waste material, for example cardboard boxes, with a pressing chamber and a hydraulic cylinder mounted on a pressing plate above the pressing chamber. To reduce the overall height of the baler for shipping, the cylinder can be lowered down into the housing. However, the conversion is time-consuming and costly. Another disadvantage of a system with a hydraulic cylinder located above the bale chamber is the associated high overall height. Therefore, balers with such a structure are unsuitable for spaces with low headroom.

Known from DE 20 2015 102 601 U1 is a baler for compacting loose material, such as cardboard boxes. Such baling presses are used, among other things, in supermarkets to compress cardboard boxes, cardboard and other packaging of sales goods that are placed loosely on or removed from sales shelves in order to minimize the volume of residual materials to be disposed of. Strapping of the pressed cardboard boxes or the like with wires or plastic straps can also be carried out directly in a baling chute of a baler housing. To compress the cardboard boxes and the like, a press plate is moved downwards by two hydraulic cylinders arranged at the top of the press shaft. This requires a large overall height of the baler. In this prior art, the arrangement of the hydraulic cylinders above a baler housing requires a large headroom in order to be able to install the baler in a building protected from the weather.

The document DE 10 2005 037 147 A1 shows a baler with a baler housing that surrounds a bale chamber, wherein a press plate can be moved in the bale chamber by a power drive consisting of four hydraulic cylinders. In each case, two hydraulic cylinders act together as a master-slave cylinder pair. Furthermore, the hydraulic cylinders can also be arranged on the side of the baler housing to reduce the overall height of the baler. The operation of a baler with master-slave hydraulic cylinders requires considerable technical expenditure, in particular specialized and therefore expensive hydraulic cylinders.

### BRIEF SUMMARY OF THE INVENTION

For the present invention, therefore, the object is to provide a baler which has a low overall headroom as well as a simplified structural design. Furthermore, a corresponding method for operating such a baler is to be specified.

These objects are achieved by a baler with a baler housing surrounding a bale chamber and with a pressing plate that is movable in the baler housing and which can be driven by hydraulic cylinders arranged in pairs on two opposite sides outside the bale chamber, characterized in that a hydraulic control device is provided, by means of which the hydraulic cylinders of each pair of cylinders can each be controlled either selectively individually or jointly, depending on the press pressure, and by a method for operating a baler with a baler housing surrounding a bale chamber and with a pressing plate that is moveable in a baler housing and which is driven by hydraulic cylinders arranged in pairs on two opposite sides outside the bale chamber, characterized in that the hydraulic cylinders of each pair of cylinders are each controlled either selectively individually or jointly, depending on the press pressure.

The essential idea of the invention is that in a baler which, as explained above, has a baler housing with a bale chamber, a pressing plate and hydraulic cylinders for driving it, a total of four hydraulic cylinders are provided, each of which is arranged in pairs on one side of the pressing plate, wherein by means of a control device the hydraulic cylinders of each pair of cylinders can each be selectively actuated individually or jointly depending on the pressing pressure.

The arrangement of the hydraulic cylinders on the side of the baler housing keeps the overall height of the baler small. This is particularly the case if the baler is designed in such a way that the hydraulic cylinders are not employed as push cylinders but as pull cylinders. In this context, a pressure cylinder is understood to be a cylinder in which the piston surface is impinged with hydraulic oil during the pressing process. A pull cylinder is a cylinder in which the piston ring surface is pressurized with hydraulic oil during the pressing process.

In the case of a baler with pull cylinders, the advantage is that the hydraulic cylinders do not protrude beyond the bale chamber or the pressing plate. In the case of two balers with the same overall height, one of which compacts the bale material with pull cylinders and the other with push cylinders, the pull cylinder baler can therefore achieve a higher and therefore larger bale chamber than a push cylinder baler. The baler with pull cylinders according to the invention is therefore particularly well suited for rooms with low headroom.

For this purpose, the hydraulic cylinders engaging the pressing plate are preferably designed in such a way that, when the pressing plate is moved to its uppermost position, they practically do not protrude above the pressing plate. In particular, the hydraulic cylinders are arranged in pairs on the left and right opposite each other on two sides of the usually rectangular pressing plate. In the lower area of the baler, there is preferably a lower transverse yoke to which the cylinders are attached.

The control device Is designed to actuate the various hydraulic cylinders of the baler with hydraulic oil in the desired manner, i.e., to move the pressing plate downward for compacting material such as cardboard boxes or the like, and also to actuate the hydraulic cylinders in the opposite direction to raise the pressing plate in a targeted manner. The control device is designed in such a way that either only one or both hydraulic cylinders of each pair of cylinders, which are arranged adjacent to one side of the pressing plate, are controlled. This offers the advantage that, when the bale chamber of the baler is still almost empty or only a material that is easy to compact has been filled in, only one hydraulic cylinder on each side of the bale plate is actuated at a time. Since only two hydraulic cylinders are pressurized with hydraulic oil in this phase, the volume required to drive the then only two driven hydraulic cylinders can be made available more quickly with an existing pump for the hydraulic oil than with four hydraulic cylinders, resulting in rapid movement of the pressing plate. The same applies to the return stroke of the pressure plate, which requires little force and for which expediently only one cylinder of each pair of cylinders is controlled.

The piston rod of the respective non-actuated cylinder is taken along by the respective adjacent actuated cylinder. For this purpose, the two hydraulic cylinders arranged on one side of the pressing plate are mechanically coupled to each other so that the piston rod of the other cylinder is also moved when the piston rod of one of the controlled hydraulic cylinders is moved up or down.

However, if greater forces are required to move the pressing plate, in particular during a final phase of a pressing stroke of the pressing plate, for example in the last third to last fifth on the way down in the bale chamber, this can be detected by a sensor of the control device, for example by the fact that the pressure in the actuated hydraulic cylinders increases and the piston rods of the hydraulic cylinders move only very slowly or no longer at all. Subsequently, the control unit can switch over depending on the press pressure in such a way that pressurized hydraulic oil is now also supplied to the two previously unpressurized hydraulic cylinders via further corresponding hydraulic lines in order to double the pressing force.

The hydraulic control device is preferably an electronic unit, such as PLC control.

Selective control of either only one hydraulic cylinder or both hydraulic cylinders on each side makes it possible to achieve much more effective operation of the press with faster movement of the press plate at low power requirements and with a high pressing force when compressing pressed material, while maintaining the same power of a hydraulic oil pump assigned to the press.

Another advantage of the invention is that due to the lateral arrangement of the hydraulic cylinders, the baler can also be set up in rooms with low ceiling heights and can also be conveyed through low doors or gates.

Advantageous embodiments of the invention are the subject of the subclaims.

In particular, the hydraulic cylinders can be controlled in such a way that, if initially only one cylinder is controlled on each side, this is done crosswise, for example the left rear and right front cylinders or alternatively the left front and right rear cylinders. In this way, a more uniform application of force to the pressing plate by the hydraulic cylinders can be achieved in order to avoid tilting of the pressing plate.

According to a further aspect, a hydraulic main switching valve and a hydraulic pressure switching valve are provided for actuating the hydraulic cylinders, which can be controlled by the hydraulic control device. The main switching valve basically determines the direction of movement of the hydraulic cylinders, i.e., raising or lowering of the pressing plate, depending on the direction in which the hydraulic cylinders are pressurized with hydraulic oil. The pressure switching valve is also used to control whether only one hydraulic cylinder or both hydraulic cylinders of the cylinder pair are pressurized with hydraulic oil on each side.

Preferably, the hydraulic cylinders are each connected to each other with a top-side transverse yoke and/or a bottom-side lower yoke. These yokes are then arranged above and below the press housing respectively. To allow hydraulic cylinders to move relative to these yokes, spherical bearings and shafts may be provided at the joints of cylinders and yokes.

Preferably, a guide is provided in the press housing for the movable pressing plate. For example, triangular, prism-shaped guide rails can be arranged on the press plate in cross-section, which interacts with corresponding guide profiles on inner surfaces of the bale chamber. This counteracts tilting of the pressing plate when pressing material together.

Particularly if the bale chamber is filled unevenly, it may occur that the pressing plate tilts, i.e., inclines against its own main plane, due to different resistances of the material to be pressed. With regard to this, the invention proposes that a position sensor detecting an inclined position of the pressing plate is associated with the pressing plate, from which position signals can be transmitted to the hydraulic control unit. In this way, the control device and the position sensor can detect any pressing plate inclination that exceeds a presettable limit value. The control unit can then control the hydraulic cylinders in such a way that the tilting is compensated, e.g., only one hydraulic cylinder is pressurized with hydraulic oil on a leading side of the pressing plate and both hydraulic cylinders are pressurized with hydraulic oil on the opposite, remaining side of the pressing plate in order to again align the pressing plate horizontally.

To operate the baler according to the invention, the hydraulic cylinders of each pair of cylinders are selectively controlled individually or jointly depending on the pressing pressure. This means that of the two hydraulic cylinders arranged on either side of the pressure plate and mechanically coupled to each other, either only one or both are controlled to raise and lower the pressure plate. When the power requirement is low, only one hydraulic cylinder of each pair of cylinders is acted upon by hydraulic oil in order to move the pressing plate down quickly or to raise it again, and when the power requirement is high, i.e., when pressing the pressed material, both hydraulic cylinders of each pair of cylinders are then pressurized with hydraulic oil.

### BRIEF DESCRIPTION OF THE DRAWINGS

In the following, an exemplary embodiment of the invention is described with reference to the drawings. The figures of the drawings show, in each case in schematic representation:

FIG. 1 shows a first exemplary embodiment of a baler in accordance with the present invention in a first perspective view;

FIG. 2 shows a second exemplary embodiment of a baler in accordance with the present invention in top view;

FIG. 3 shows a third exemplary embodiment of a baler in accordance with the present invention in a perspective view;

FIG. 4 shows a pair of hydraulic cylinders of the baler of FIG. 2 in a side view; and

FIG. 5 a circuit diagram of the hydraulic system of the baler of FIG. 2, together with some other parts of the baler of FIG. 2.

### DETAILED DESCRIPTION OF PREFERRED EMBODIMENTS

In the following description of the figures, the same parts in the various figures are always given the same reference numbers, so that it is not necessary to explain all the reference numbers again for each figure.

Further, the figures of the drawing, the description thereof, and the claims contain numerous features in combination. It is clear to a person skilled in the art that these features can also be considered individually or they can be combined to form further combinations not described in detail here. The invention expressly extends to such embodiments which are not given by combinations of features from explicit recitations of the claims, whereby the disclosed features of the invention can be combined with each other in any way, as far as this is technically reasonable. Thus, the exemplary embodiments shown in the figures are descriptive only and are not intended to limit the invention in any way.

The terms used hereinafter: “upper”, “top”, “bottom”, “left”, or “right” refer to the arrangement of the components of the baler corresponding to the operating mode shown in the drawing.

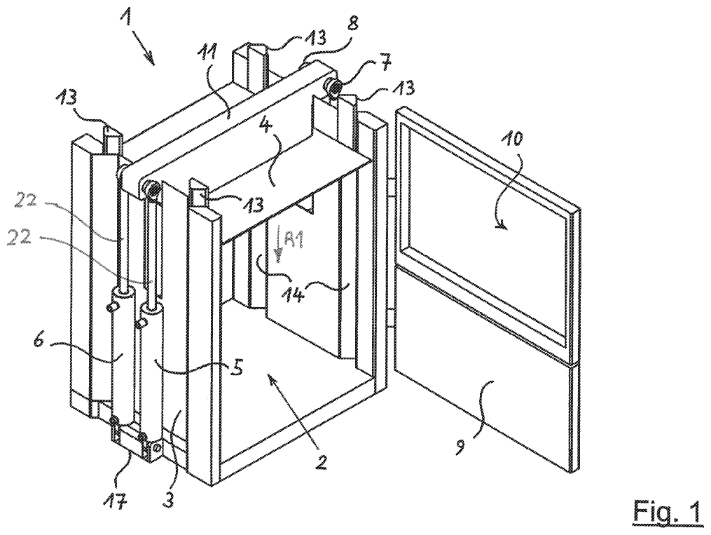

FIG. 1 shows a first exemplary embodiment of baler 1 with a baler housing 3, for example made of steel, and a bale chamber 2, whose chamber door 9 forming a front side of the baler housing 3 is open here. In its upper part, the chamber door 9 is provided with a feed opening 10. When the chamber door 9 is closed, bale material such as cardboard boxes, cardboard, packaging or empty plastic beverage bottles, which are produced in supermarkets for example, can be fed into the bale chamber 2 through the feed opening 10.

The material to be baled is then moved and compacted in the direction of R1 by a pressing plate 4, which is shown here in a raised, upper position, preferably strapped with wire or plastic straps, and then removed as a pressed bale when the chamber door 9 is open. Thus, the volume of the materials to be disposed of is considerably reduced and the bales can be easily stored and transported.

The pressing plate 4 is moved here by means of four hydraulic cylinders 5, 6, 7, 8 arranged in pairs on the side of the baler housing 3, whereby only the two hydraulic cylinders 5, 6 are completely visible in FIG. 1. The two further hydraulic cylinders 7, 8, are arranged on the side of the baler housing 3 facing away from the viewer here and are largely concealed. The hydraulic cylinders 5, 6, 7, 8 each have a piston 23 and a piston rod 22. The pistons 23 each have a piston surface 25 on one side and a piston ring surface 24 surrounding the piston rod 22 on the other side. Due to the fact that the hydraulic cylinders 5, 6, 7, 8 are arranged laterally on the baler housing 3, the overall height of the baler 1 is advantageously low. The overall height is also made particularly low by the fact that the hydraulic cylinders 5, 6, 7, 8 are designed as pull cylinders, each of which is pressurized with hydraulic fluid on its piston ring surface 24 during its movement in pressing direction R1.

The pressing plate 4 is connected at its lateral edges with here four vertical, prism-shaped guide rails 13, which project upwards beyond the pressing plate 4 and which interact with corresponding guide profiles 14 on the two lateral inner surfaces of the press housing 3.

The two hydraulic cylinders 5, 6 on one side and the two further hydraulic cylinders 7, 8 on the other side are connected to each other at the top by means of an upper transverse yoke 11 and at the bottom by means of a lower yoke 17 running parallel to the upper transverse yoke below the bale chamber 2 within each pair of cylinders and from cylinder pair to cylinder pair. In addition, the upper transverse yoke 11 is connected to the upper side of the pressing plate 4.

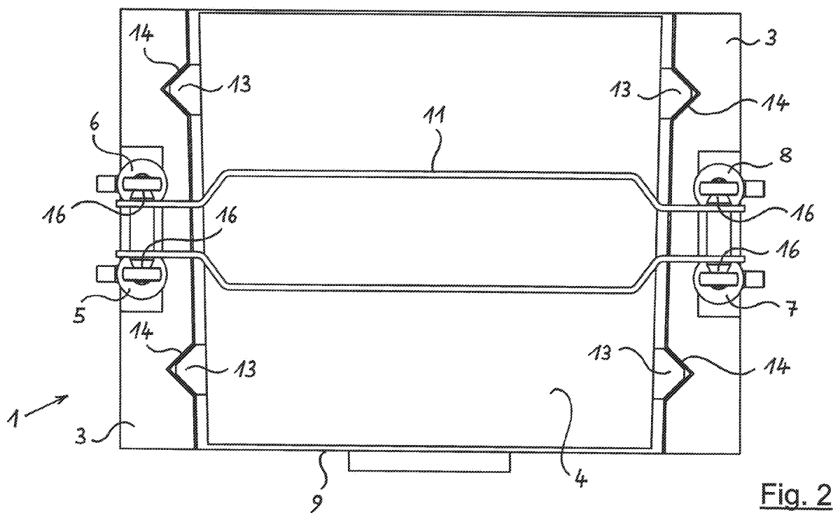

FIG. 2 shows a top view of a second exemplary embodiment of baler 1. The four hydraulic cylinders 5, 6, 7, 8 engage here laterally in pairs opposite each other via the upper transverse yoke 11 on the pressing plate 4. The hydraulic cylinders 5, 6 of one side and the hydraulic cylinders 7, 8 of the other side are connected to each other by means of the upper transverse yoke 11. The transverse yoke 11 provides a mechanical coupling of the hydraulic cylinders 5, 6, 7, 8.

Furthermore, the pressing plate 4 has on its lateral edges the four vertical prismatic guide rails 13 which interact with the corresponding guide profiles 14 on the inner surface of the press housing 3. These guide rails 13 and guide profiles 14 counteract tilting of the pressing plate 4, since when the pressing plate 4 tilts on the leading side there is increased frictional resistance of the guide rails 13 there in the guide profile 14, so that the pressing plate 4 is braked on this side and almost automatically aligns itself horizontally again.

The four hydraulic cylinders 5, 6, 7, 8 are each connected to the upper transverse yoke 11 via a joint bearing 16.

At the bottom of FIG. 2 is the chamber door 9, which is closed here.

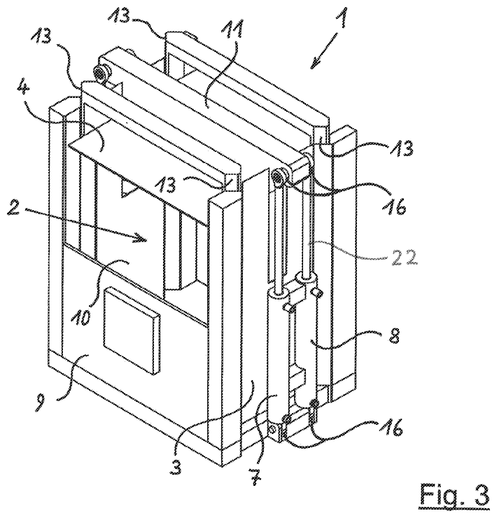

FIG. 3 shows a third exemplary embodiment of baler 1 in a perspective view diagonally from the front. Here, the pressing plate 4 of the baler 1 is in the raised position. Furthermore, it can be seen that two hydraulic cylinders 5, 6 and 7, 8, respectively, arranged on one side of the pressing plate 4 are mechanically coupled to each other. This coupling takes place via the joint bearings 16, which here engage with the upper transverse yoke 11. Furthermore, the guide rails 13 at the edge of the pressing plate 4 are also connected to each other here parallel to the transverse yoke 11, which serves to increase the mechanical stability of the pressing plate 4.

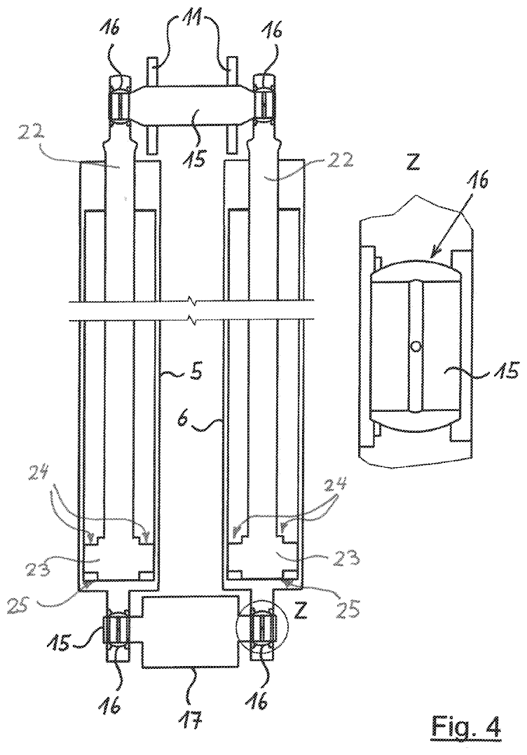

FIG. 4 shows a side view of two adjacent hydraulic cylinders 5, 6, each of which is connected to the other via the upper transverse yoke 11 and the lower yoke 17. The joint bearings 16 are used for the articulated connection of these components to each other. The outer piston rod ends of the cylinders 5, 6 are connected at the top to the upper transverse yoke 11 by means of the joint bearings 16 there, and the cylinder housings of the cylinders 5, 6 are connected at the bottom to the lower yoke 17 by means of the joint bearings 16 there. On the other side of the press housing, which is not shown here, there is a mirror-symmetrical arrangement with the further two hydraulic cylinders 7, 8 there.

The lower joint bearing 16 shown in FIG. 4 on the right is shown again in enlargement of the detail Z on the right in FIG. 4.

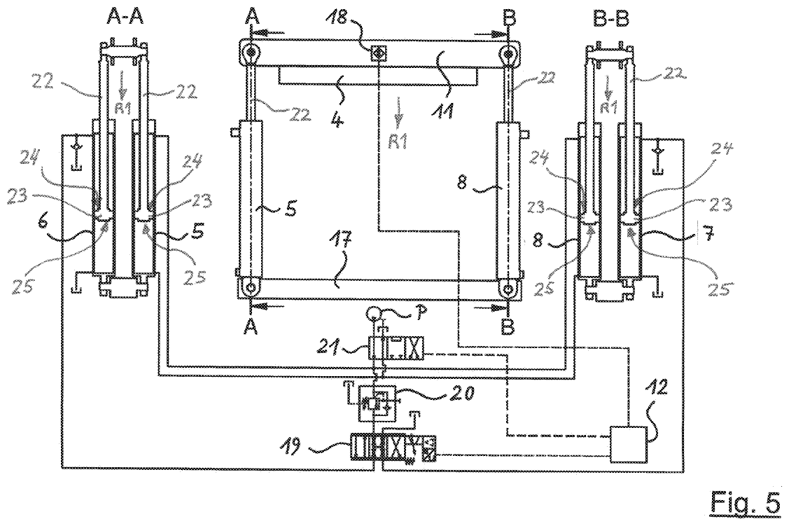

In FIG. 5, an exemplary hydraulic circuit diagram of the hydraulic system of the baler 1 is shown together with several other parts of the baler 1 to illustrate the hydraulic components and the hydraulic connections, shown as continuous lines, of the various components of the baler 1. Sections A-A and B-B are shown schematically at the sides in FIG. 5.

A total of four hydraulic cylinders 5, 6, 7, 8 engage the upper transverse yoke 11 on the pressing plate 4 of the baler 1 in order to move it with the pressing plate 4 downward in pressing direction R1 or to raise it in the opposite direction to pressing direction R1.

A position sensor 18, such as an inclination angle sensor, is arranged on the pressing plate 4 or, as shown here, on the transverse yoke 11, in order to register a tilting of the pressing plate 4 from its horizontal position. The position sensor 18 is in communication with a control device 12, as indicated by the dashed line.

The control device 12, in turn, is connected to a main switching valve 19 via a control line and can control the hydraulic cylinders 5, 6, 7, 8 via said switching valve.

In addition, the hydraulic system includes a pressure switching valve 20 connected upstream of the main switching valve 19 and switching as a function of hydraulic pressure.

In operating phases of the baler with low power requirements, only the two hydraulic cylinders 5, 8 are controlled in such a way that these hydraulic cylinders 5, 8 move the pressing plate 4 up or down. The other hydraulic cylinder 6, 7 of each pair of cylinders is driven by the respective hydraulic cylinder 5, 8 due to their mechanical coupling. The hydraulic cylinders 6, 7 that are entrained fill up with hydraulic oil from a hydraulic oil tank of the hydraulic system via a tank line with a check valve arranged therein in a pressureless manner due to the vacuum created in the post-suction process.

In the event of a greater force requirement which can be determined by an increase in hydraulic oil pressure, in particular when pressing the bale material, the pressure switching valve 20 is controlled in such a way that the two other hydraulic cylinders 6, 7 are also controlled and pressurized with pressurized hydraulic oil in order to then generate a higher, approximately double pressing force of the pressure plate 4 with all four pressurized hydraulic cylinders 5, 6, 7, 8.

Two hydraulic cylinders are controlled crosswise by the control device 12 when the power requirement is low, for example, only hydraulic cylinders 5, 8 or hydraulic cylinders 6, 7. Only when a greater load occurs during lowering of the pressing plate 4, i.e., when there is already much bale material or material that is difficult to compress in the press chamber, are the other two respective hydraulic cylinders 6, 7 or 5, 8 controlled. This means that a hydraulic oil pump then feeds the hydraulic oil to all four hydraulic cylinders 5, 6, 7, 8.

Should the pressing plate 4 tilt during the pressing process, which is detected by the position sensor 18 and transmitted to the control device 12, the hydraulic cylinders 5, 6, 7, 8 can be controlled accordingly by means of the control device 12 and the main switching valve 19 in order to compensate for this tilting.

A directional switching valve 21 is used to switch the direction of movement of the hydraulic cylinders 5, 6, 7, 8 and thus of the pressing plate 4. This directional switching valve is arranged between a hydraulic oil pump P, which is responsible for hydraulic oil delivery and hydraulic oil pressure generation, and the pressure switching valve 20.

A typical operating cycle of baler 1 is as follows:

Initially, the baler 1 is in a filling state, with the hydraulic cylinders 5, 6, 7, 8 in the raised position, i.e., in the position in which they are when the pressing plate 4 is in its uppermost position for the purpose of filling the bale chamber 2. Through the open chamber door 9, bale material is fed manually or mechanically into the bale chamber 2 until a presettable filling level is reached, and the chamber door 9 is closed.

From this position, the hydraulic cylinders 5, 8 or 6, 7 are filled with hydraulic oil by the pump P in the annular space of the cylinders for pressing the bale material, which is located below the pressing plate 4. Thus, of each pair of cylinders 5, 6 and 7, 8 attached to the side of the press 1, only one cylinder 5 and 8 is filled with oil. When hydraulic oil is now filled into the annular space of the cylinders 5, 8 connected to the pump P, the piston rods of these cylinders 5, 8 and thus the pressing plate 4 connected to it move downwards.

The cylinders 5, 6 and 7, 8 of a pair of cylinders are each mechanically connected to one another. Thus, when the piston rod of one cylinder 5, 8 moves downward in pressing direction R1, the piston rod of the other respective cylinder 6, 7 is also moved downward in pressing direction R1 by mechanical force transmission via the mechanical connection. In the process, the hydraulic cylinders 6, 7 that are moved along fill with hydraulic oil from a hydraulic oil tank of the hydraulic system without pressure via a tank line with a check valve arranged therein due to the vacuum created in the post-suction process.

The cylinders 5, 8 to be filled with hydraulic oil at low power requirements and low pressing pressures are arranged crosswise, i.e., cylinder 5 is hydraulically connected to cylinder 8. The cylinders 5, 8 are filled with pressurized hydraulic oil in the operating state in which the pressure switching valve 20 has not yet switched over to filling all cylinders 5, 6, 7, 8. In the process, the pressing plate 4 moves down relatively quickly in the vast majority of the pressing cycle without building up much pressure.

With the bale chamber 2 already filled to a certain extent, the pressure for pressing the bale material is initially only required in the lower part, approximately the lower third to fifth of the bale chamber 2. Then, via the pressure switching valve 20, the hydraulic oil flow is not only released into the hydraulic cylinders 5 and 8, but the hydraulic cylinders 6 and 7 next to them are also supplied with pressurized hydraulic oil.

At the time when such a changeover of the pressure switching valve 20 takes place, the pressing plate 4 is already in the lower part of the bale chamber 2. The pairs of cylinders 5, 6 and 7, 8 on each side of the pressing plate 4 are connected to each other via the transverse yoke 11, which is located above the pressing plate 4.

Guide rails 13 are located on the pressing plate 4 and interact with the compatibly shaped guide profiles 14 in the side walls of the bale chamber 2. If, for example, a different pressure builds up under the right-hand part of the pressing plate 4 than under the left-hand part, the pressing plate 4 is skewed so that the cylinders 5, 6 or 7, 8 on one side receive less oil than the cylinders 7, 8 or 5, 6 on the other side.

The guide rails 13, which interact with the guide profiles 14 in the side wall and extend upwards from the pressing plate 4, ensure that when a pair of cylinders 5, 6 or 7, 8 is advanced and the pressing plate 4 tilts as a result, the guide rails 13 and guide profiles 14 on the leading side cause greater friction between them than the guide rails 13 and guide profiles 14 on the trailing side of the pressing plate 4. As a result, the initially leading guide through the guide rails 13 and guide profiles 14 becomes sluggish, so that the hydraulic oil flows preferentially into the other pair of cylinders 7, 8 or 5, 6 and leads to a compensation of the leading of one side of the pressure plate 4, acting against the inclined position.

However, if the inclined position of the pressing plate 4 becomes too great, this is detected by means of the position sensor 18, e.g., an angle sensor, mounted on the transverse yoke 11 above the pressing plate 4, and reported to the control device 12. If the inclined position exceeds a certain, predefinable limit value, then the directional switching valve 21 of the hydraulic system is set to return by the control device 12 and the pressing plate 4 moves back to its upper starting position. At the end of the retraction at the latest, the pressing plate 4 aligns itself horizontally again by running against an upper stop, after which it can be moved down again from there for a new pressing step.

At the end of the last pressing step, i.e., when a bale has been pressed completely, the pressing plate 4 is in its lower position. In this position of the pressing plate 4, the bale can be tied in a known manner. From this position, the pressing plate 4 is moved back up again after the directional switching valve 21 has been switched over. Here, too, only two cylinders 5, 8 are pressurized with hydraulic oil in the return stroke, so that a relatively fast return of the pressing plate 4 to the top is achieved due to the small hydraulic oil volume required for this. The twin cylinder 6, 7 connected to the respective cylinder 5, 8 is not moved upwards by pressurized hydraulic oil flowing into its pressure chamber, but is driven by the respective adjacent hydraulic cylinder 5, 8 due to the mechanical connection and due to the power transmission taking place via this. The hydraulic oil released in the annular space of the hydraulic cylinders 6, 7 runs into the unpressurized hydraulic oil tank. For this purpose, the hydraulic cylinders 6, 7 are connected to the hydraulic oil tank on their bottom side only via mere leakage oil lines and can also draw air when the cylinders 5, 8 are extended. The piston chamber of the hydraulic cylinders 6, 7 carried along therefore never needs to be pressurized with hydraulic oil.

After the upper starting position of the pressing plate 4 has been reached, the chamber door 9 can be opened and the pressed and tied bale can be removed from the bale chamber 2.

### LIST OF REFERENCE NUMBERS

1 baler
2 bale chamber
3 baler housing
4 pressing plate
5 hydraulic cylinder
6 hydraulic cylinder
7 hydraulic cylinder
8 hydraulic cylinder
9 chamber door
10 feed opening
11 transverse yoke
12 control device
13 guide rail
14 guide profile
15 shaft
16 joint bearing
17 lower yoke
18 position sensor
19 main switching valve
20 pressure switching valve
21 directional switching valve
22 piston rod
23 piston
24 piston ring surface
25 piston surface
A-A section
B-B section
R1 pressing direction
Z detail (from FIG. 3)

1. A baler (1) with a baler housing (3) surrounding a bale chamber (2) and with a pressing plate (4) that is movable in the baler housing (3) and which can be driven by hydraulic cylinders (5, 6, 7, 8) arranged in pairs on two opposite sides outside the bale chamber (2), the baler (1) comprising a hydraulic control device (12) by means of which the hydraulic cylinders (5, 6, 7, 8) of each pair of cylinders (5 and 6, 7 and 8) can each be controlled either selectively individually or jointly, depending on the press pressure.

2. The baler (1) as claimed in claim 1, wherein, in the case of individual control of a respective hydraulic cylinder (5 or 6, 7 or 8) of each side, the hydraulic cylinders (5 and 8 or 6 and 7) can be controlled crosswise.

3. The baler (1) as claimed in claim 1, wherein for the actuation of the hydraulic cylinders (5, 6, 7, 8) a hydraulic main switching valve (19) and a hydraulic pressure switching valve (20) are provided, which can be controlled by the hydraulic control device (12).

4. The baler (1) as claimed in claim 1, wherein the hydraulic cylinders (5, 6, 7, 8) are each connected to one another by a top-side transverse yoke (11) and/or a bottom-side lower yoke (17).

5. The baler (1) as claimed in claim 1, further comprising a guide for the pressing plate (4) formed in the baler housing (3).

6. The baler (1) as claimed in claim 1, wherein in that the pressing plate (4) is assigned a position sensor (18) which detects an inclined position of the pressing plate (4) and from which position signals can be transmitted to the hydraulic control device (12).

7. The baler (1) as claimed in claim 1, wherein the hydraulic cylinders (5, 6, 7, 8) are double-acting cylinders which comprise a piston rod (22) and a piston (23) and in which the piston (23) has a piston surface (25) on one side and a piston ring surface (24) surrounding the piston rod (22) on the other side, and wherein the control device (12) is designed in such a way that, during the movement of the pressing plate (4) in the pressing direction (R1), the piston ring surfaces (24) of the pistons (23) are acted upon by a hydraulic fluid, so that the cylinders (5, 6, 7 and 8) act as pull cylinders.

8. A method for operating a baler (1) with a baler housing (3) surrounding a bale chamber (2) and with a pressing plate (4) that is moveable in a baler housing (3) and which is driven by hydraulic cylinders (5, 6, 7, 8) arranged in pairs on two opposite sides outside the bale chamber (2), comprising controlling each of the hydraulic cylinders (5, 6, 7, 8) of each pair of cylinders either selectively individually or jointly, depending on the press pressure.

9. The method as claimed in claim 8, wherein in the case of individual control of a respective hydraulic cylinder (5 or 6, 7 or 8) of each side, the hydraulic cylinders (5 and 8 or 6 and 7) are controlled crosswise.

10. The method as claimed in claim 8, wherein the hydraulic cylinders (5, 6, 7, 8) moving the pressing plate (4) have a piston (23) with a piston surface (25) and a piston ring surface (24) and, when the pressing plate (4) is moved in the pressing direction (R1), are acted upon at their piston ring surface (24) by a hydraulic fluid.
